(19) United States
(12) Patent Application Publication
(10) Pub. No.: US 2019/0016180 A1
(43) Pub. Date: Jan. 17, 2019

(54) CARBON FIBER HYBRID CORD AS BEAD WIRE

(71) Applicant: KORDSA TEKNIK TEKSTIL ANONIM SIRKETI, Izmit/Kocaeli (TR)

(72) Inventors: Mehmet Sadettin FIDAN, Istanbul (TR); Kursat AKSOY, Kocaeli (TR); Neslihan GULBEYCAN, Kocaeli (TR)

(73) Assignee: KORDSA TEKNIK TEKSTIL ANONIM SIRKETI, Izmit (TR)

(21) Appl. No.: 16/069,880

(22) PCT Filed: Jan. 12, 2016
(86) PCT No.: PCT/TR2016/050011

§ 371 Date: Jul. 12, 2018

(51) Int. Cl. B60C 15/04; B60C 9/00

(52) U.S. Cl. CPC B60C 15/04; B60C 2015/042; B60C 9/005

(57) ABSTRACT

A bead in peneumati radial tires consisting of hybrid cords made of carbon fibers and lower modulus organic yarns, which enables easy mounting the tire to the rims. The light weight bead structure with hybrid cords within rubber or polymeric matrix makes it possible to reduce the fuel consumption.

### CROSS REFERENCE TO THE RELATED APPLICATIONS

This application is the national phase entry of the International Application no. PCT/TR2016/050011, filed on Jan. 12, 2016, the entire content of which is incorporated herein by reference.

### TECHNICAL FIELD

This invention relates to a tire which is provided with a light weight bead core. In particular, the present invention relates to a tire which is provided with a light weight bead core, said bead core contributing in decreasing the overall tire weight.

### BACKGROUND

In principle, bead area of the pneumatic tire is required to have an enhanced rigidity because it plays a role of positioning and strongly fixing the tire to a rim. The bead core is formed by helically winding and spirally laminating the cord to form a cord arrangement of plural rows×columns.

It is well known common practice in the tire industry that the reinforcing elements in bead members are steel wires arranged either side-by-side or twisted into cables which are normally embedded in rubber.

In U.S. Pat. No. 3,942,574 three ply aramid cords have been proposed as bead member in combination with steel wires to obtain a stable bead structure in aircraft tires.

In U.S. Pat. No. 4,098,316 a glass fiber reinforced bead rins in combination with metal wires have been disclosed. Glass fibers as bead reinforcing elements have been suggested also in U.S. Pat. No. 3,612,139, U.S. Pat. Nos. 3,473,595 and 3,237,674.

In order to reduce tire weight and to realize fuel saving, in place of steel wires conventionally used as bead members in pneumatic tires, it has been proposed to use high modulus nonmetallic (organic or inorganic) untwisted fibers like aramid treated with liquid rubbers or thermosetting resins in U.S. Pat. No. 4,320,791.

In U.S. Pat. No. 4,823,857 an annular bead member for a tire comprising two or more radially superposed layers each of which comprising composite of fibers in polymeric matrix have been disclosed. The superposed layers have been separated from each other with polytetrafluoroethylene layers to facilitate lateral movement of the composite layers. The fibers in composite layers are selected from the group consisting of glass fibers, aramid fibers, carbon fibers, polyamide fibers and metallic fibers. U.S. Pat. No. 6,318,430 and EP2644410 are also known from the prior art which are related to a bead structure comprising composite material.

According to U.S. Pat. No. 5,781,603, in a pneumatic tire comprising a bead core formed by helically winding and spirally laminating a organic or inorganic fiber cord obtained by two or more ply twisting in one direction and a twisting of at least two twisted fiber reinforcing elements in a direction opposite to the twisting direction of the fiber reinforcing element, wherein the cord twisting is higher than initial yarn twisting. Preferably, cords are made of heavy dtex aramid (e.g. 6600×2) to improve stress distribution within bead core in inflated tire.

### SUMMARY

According to this invention, there is a bead ring for a pneumatic radial tire comprising hybrid cords made of carbon fiber and lower modulus organic yarns like PET and nylon 6.6.

The tires having bead rings made of carbon fiber or carbon fiber cords have problem with tire mountability to the rims of wheels due to their extremely low extensibility. Such kind of bead ring elements experience cord breaks under bending compression during tire mounting. Hybrid structures containing carbon fiber and low modulus yarns like PET and nylon 6.6 have sufficient extensibility enabling easy tire mounting to the rims of the wheel. Further more, with this invention, by decreasing tire weight the fuel consumption is reduced.

### DETAILED DESCRIPTION

The present invention provides a pneumatic radial tire comprising as a structural component thereof a bead element made of a hybrid cord having carbon fiber and lower modulus organic yarn like PET and nylon 6.6.

According to this invention, elongation at break values of the hybrid cords in bead ring must be minimum 2% and maximum 5%. If the elongation at break value is lower than 2%, tire mounting to the rims of the wheel becomes difficult, and cord can be broken due to tensile and compressive deformations. In case of higher elongation at break values than 5%, cord modulus becomes too low for fixing tire on rims of the wheel.

The weight percentage of the low modulus organic yarn in carbon fiber hybrid cord determines the extensibility, in other words elongation at break and modulus values. If the content of low modulus organic yarn is higher than 50%, hybrid cord becomes less effective in fixing the tire to the rims, and if the content of low modulus organic yarn is lower than 20%, tire mounting becomes difficult due to reduced extensibility.

According to the invention, in order to increase the hybrid cord extensibility for a given cord twist, the overfeed percentage of the carbon fiber yarn during twisting process with direct cabler can adjusted to minimum 1% and maximum 2.5%. The overfeed values less than 1% is not effective enough to increase cord extensibility, and the overfeed values higher than 2.5% results in significant initial modulus drop which cause reduced fixing function of the hybrid cord.

According to the invention, the preferable total nominal dtex of the hybrid cords is of 2,000 dtex to 20,000 dtex.

Of course, the extensibility of the hybrid cord can be adjusted also with cord twist, that means, by increasing cord twist, extensibility and elongation at break can be enhanced, but in this case cord modulus and strength are reduced. That's why, preferable minimum cord twist is 80 tpm, and maximum cord twist is 300 tpm. If the cord twist less than 80 tpm, extensibility becomes too low, and if the cord twist higher than 300 tpm, breaking strength and modulus becomes insufficient.

According to the present invention, some examples of the hybrid cords with their physical properties are given in table-1

TABLE 1 [symbol]
hybrid

[symbol]

| | CF8000dtex + | CF8000dtex + | CF4000dtex + | CF4000dtex + |
|---|---|---|---|---|
| | PET6600dtex | NYG300dtex | PET3300dtex | NY2800dtex |
| | 100 tpm/100 tpm, Z/S | 100 tpm/100 tpm, Z/S | 140 tpm/140 tpm, Z/S | 140 tpm/140 tpm, Z/S |
| Breaking force(kg) | 144.3 | 112.5 | 75.1 | 55.8 |
| Elongation at | 3.6 | 3.1 | 3.7 | 3.2 |
| break(%) | | | | |
| 1% LASE(kg) | 33.5 | 29.2 | 17.4 | 14.1 |
| CF overfeed(%) | 2 | 2 | 2 | 2 |

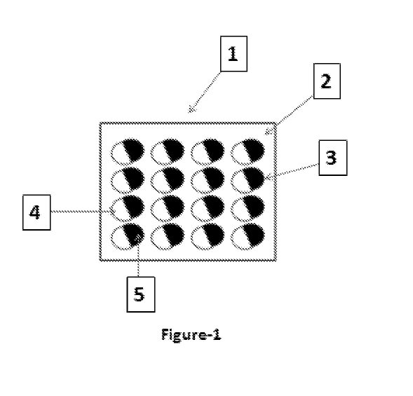

As an example of the bead application, the cross section of a bead ring according to invention is given enclosed as FIG. 1, and the bead components are;
1—Cross section of the bead ring
2—Rubber or polymeric matrix
3—Hybrid cord
4—Low modulus organic yarn (e.g. nylon 6.6) in hybrid cord
5—Carbon fiber in hybrid cord

### Definitions

Bead core: An annular hoop reinforcement in the bead region of the tire, commonly formed of high modulus cords or cables

Cord: Means a cable formed by twisting together two or more plied yarns

Denier: The weight in gramms per 9,000 meters (unit for expressing linear density)

Dtex: The weight in gramms per 10,000 meters (unit for expressing linear density)

Hybrid cord: A cord constructed by helically twisting together a plurality of individual yarns, at least one of the individual yarns being of a material different from the material of at least one of the other individual yarns.

LASE: Load at specified elongation

1% LASE: Load at 1% elongation

Modulus: Stress divided by strain, resistance to deformation

Nominal cord linear density: Sum of the initial yarn linear densities of the cord (e.g. 1880 dtex for 940×2 cord construction) Radial tire: A belted or cicumferentially restricted pneumatic tire in which the body ply or carcass cords which extend from bead to bead are laid at cord angles between 65° and 90° with respect to the equatorial plane of the tire.

Rim: A support for a tire upon which the tire beads are seated

TPM: Number of turns per meter

Twist: The number of turns about its axis per unit of length of a yarn or cord, turns per meter being tpm.

1- A bead of radial pneumatic tire consisting of plurality of two-ply or three-ply hybrid cords composed of carbon fiber and lower modulus organic yarn is characterized that,
the elongation at break value of the hybrid cords determined by ASTM D885 is higher than 2% and less than 5%

2- One of the plies of the said hybrid cords in claim-1 is nylon 6.6 yarn as low modulus organic yarn.

3- One of the plies of the said hybrid cords in claim-1 is PET yarn as low modulus organic yarn.

4- The weight percentage of the low modulus organic yarn in the said hybrid cord in claim-1 is less than 50% and higher than 20%

5- Overfeed percentage of carbon fiber in said hybrid cord in claim-1 is minimum 1% and maximum 2.5%.

6- The total nominal dtex of the said hybrid cords in claim-1, is of 2,000 to 20,000 dtex

7- The cord twist of the hybrid cords in claim-1, is 80 to 300 tpm.
